(19) United States
(12) Patent Application Publication
(10) Pub. No.: US 2013/0268611 A1
(43) Pub. Date: Oct. 10, 2013

(54) METHOD FOR SENDING AN ENHANCED VISUAL VOICE MAIL AND AN APPARATUS THEREFOR

(71) Applicant: Basavaraj Jayawant Pattan, Bangalore (IN)

(72) Inventor: Basavaraj Jayawant Pattan, Bangalore (IN)

(73) Assignee: Samsung Electronics Co. Ltd, Gyeonggi-do (KR)

(21) Appl. No.: 13/994,073

(22) PCT Filed: Dec. 13, 2011
(86) PCT No.: PCT/KR2011/009585

§ 371 Date: Jun. 13, 2013

(30) Foreign Application Priority Data
Dec. 13, 2010 (IN) 3814/CHE/2010

(51) Int. Cl. H04L 12/58

(52) U.S. Cl. CPC H04L 51/08
USPC 709/206

(57) ABSTRACT

The present invention provides a method and system for an enhanced visual voice mail (VVM). In one embodiment, emotion and blank indications are included in a voice mail (VM) and deposited on a server. The server may send a SYNC SMS notification including emotion and blank indication headers to the client via the VM server. The client initiates IMAP connection setup to the VM server and the user is authenticated by the VVM server based on the received SYNC SMS notification. Then, the client may select VM INBOX and then the VM server sends a list of VM available for playback. Further, the client may fetch VM headers of the VMs available for playback and as a result, the server returns the header information including emotion and blank indications. Moreover, the server returns the VM selected by the client based on the emotion and blank indication.

### CROSS REFERENCE TO RELATED APPLICATION AND CLAIM OF PRIORITY

The present application claims priority under 35 U.S.C. §365 to International Patent Application No. PCT/KR2011/009585 filed Dec. 13, 2011, entitled “METHOD FOR SENDING AN ENHANCED VISUAL VOICE MAIL”. International Patent Application No. PCT/KR2011/009585 claims priority under 35 U.S.C. §365 and/or 35 U.S.C. §119(a) to Indian Patent Application No. 3814/CHE/2010 filed Dec. 13, 2010 and which are incorporated herein by reference into the present disclosure as if fully set forth herein.

### TECHNICAL FIELD

The present invention relates to communication and more particularly relates to visual voice mail system and method.

### BACKGROUND

Today's Visual Voice Mail (VVM) systems are provided with an interface for displaying a list of Voice Mail (VM) available for playback and metadata information of each VM. Displaying metadata information extracted from the VM available for playback aids a user in selective viewing of the VM. The metadata includes details such as sender, deposit date, length of message, etc.

However, with the current VVM systems, the sending user can only indicate message sensitivity and message importance while depositing the VM. The current VVM systems do not provide different indications (emotions, blank) associated with the VM to recipient user. As a consequence, the recipient user has to playback all the available VMs.

### SUMMARY

The present invention has been made to solve at least the aforementioned problems found in the prior art, and to provide a method for different indications (emotions, blank) associated with the VM to recipient user.

In accordance with an aspect of the present invention, there is provided a method for sending and receiving a voice mail in a voice mail server, the method comprising the steps of receiving the voice mail from a first client; generating a notification short message including emotion indication or blank indication corresponding to the received voice mail; and sending the notification short message to a second client.

In accordance with an aspect of the present invention, there is provided a method for sending and receiving a voice mail in a client, the method comprising the steps of receiving a notification short message from a voice mail server that has received the voice mail from a first client; detecting a header of the voice mail from the notification short message; requesting the voice mail server to send the voice mail based on the header; and receiving voice mail content corresponding to the voice mail from the voice mail server.

In accordance with an aspect of the present invention, there is provided a voice mail server for sending and receiving a voice mail, the voice mail server comprising a communication interface configured to receive the voice mail from a first client; and a processor configured to control the communication interface to generate a notification short message including emotion indication or blank indication corresponding to the received voice mail and send the notification short message to a second client.

The present invention can provide a method for different indications (emotions, blank) associated with the VM to recipient user.

### BRIEF DESCRIPION OF THE DRAWINGS

FIG. 1 is a block diagram illustrating a visual voice mail system, according to an embodiment of the present disclosure;

FIG. 2 is process flowchart diagram of a method for sending and receiving a voice mail in the voice mail system, as shown in FIG. 1, according to an embodiment of the present disclosure;

FIG. 3 is process flowchart diagram of a method for sending and receiving a voice mail in the voice mail system, as shown in FIG. 1, according to another embodiment of the present disclosure;

FIG. 4 is a block diagram illustrating a voice mail server comprised in the visual voice system such as those shown in FIG. 1, according to an embodiment of the present disclosure; and

FIG. 5 is a block diagram illustrating a client comprised in the visual voice system such as those shown in FIG. 1, according to an embodiment of the present disclosure.

### DETAILED DESCRIPTION

Hereinafter, various embodiments of the present invention will be described with reference to the accompanying drawings. In the following description, the same elements will be designated by the same reference numerals although they are illustrated in different drawings. Further, a detailed explanation of known functions and constitutions may be omitted to avoid unnecessarily obscuring the subject matter of the present invention.

In accordance with an aspect of the present invention, there is provided a method for sending and receiving a voice mail in a voice mail server, the method comprising the steps of receiving the voice mail from a first client; generating a notification short message including emotion indication or blank indication corresponding to the received voice mail; and sending the notification short message to a second client.

In accordance with an aspect of the present invention, there is provided a method for sending and receiving a voice mail in a client, the method comprising the steps of receiving a notification short message from a voice mail server that has received the voice mail from a first client; detecting a header of the voice mail from the notification short message; requesting the voice mail server to send the voice mail based on the header; and receiving voice mail content corresponding to the voice mail from the voice mail server.

In accordance with an aspect of the present invention, there is provided a voice mail server for sending and receiving a voice mail, the voice mail server comprising a communication interface configured to receive the voice mail from a first client; and a processor configured to control the communication interface to generate a notification short message including emotion indication or blank indication corresponding to the received voice mail and send the notification short message to a second client.

The present invention provides a method and system for an enhanced visual voice mail (VVM). The present invention provides an enhanced VVM system to indicate emotions or blank VVM to a recipient user, thereby enabling selective viewing of the VVM. In one of the embodiments, this can be achieved through providing emotion or blank information in headers of the VM as described below.

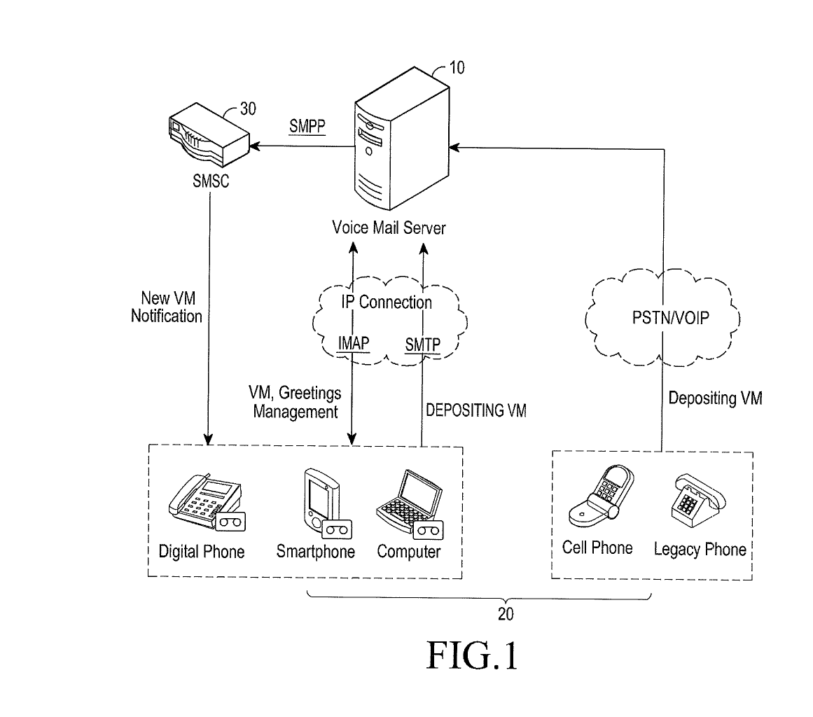

FIG. 1 is a block diagram illustrating a visual voice mail system, according to an embodiment of the present invention.

Referring to FIG. 1, the voice mail system comprises a voice mail server 10, clients 20. The voice mail system may further comprise a short message service center (SMSC) 30. The clients 20 comprise VVM devices, e.g., a digital phone, a smartphone, a computer, a cell phone, a legacy phone.

The voice mail server 10 is connected with the clients 20 through IP connection. The voice mail server 10 receives a voice mail through internet messaging access protocol (IMAP). The clients 20 may transfer the voice mail through public switched telephone network (PSTN) or voice over internet protocol (VOIP). The voice mail server 10 and the clients 20 may manage the voice mail through simple mail transfer protocol (SMTP). The SMSC 30 may inform the client 20 that one or more new voice mails are transferred.

1. IMAP Header Format of Emotion Indication:

New header: “X-CNS-EmotionIndication”

Description: Indicates the message's emotion as specified by the VM depositor or determined by Client/Server.

This header is Optional.

Legal Values: happy, sad, angry, surprise, etc.

Default Value: N/A

2. SYNC SMS Field Reference for Emotion Indication:

New header: em

Description: Indicates the message's emotion as specified by the VM depositor or determined by client/server.

This header is Optional.

Legal Values: h=happy, s=sad, a=angry, p=surprise, etc.

Default Value: N/A

3. IMAP Header Format of Blank Indication:

New header: “X-CNS-BlankIndication”

Description: Determines the message deposited is blank or not.

This header is mandatory.

Legal Values: blank, not-blank

Default Value: N/A

4. SYNC SMS Field Reference for Blank Indication:

New header: bk

Description: Determines the message deposited is Blank or not.

This header is Mandatory.

Legal Values: b=blank, nb=not blank

Default Value: nb

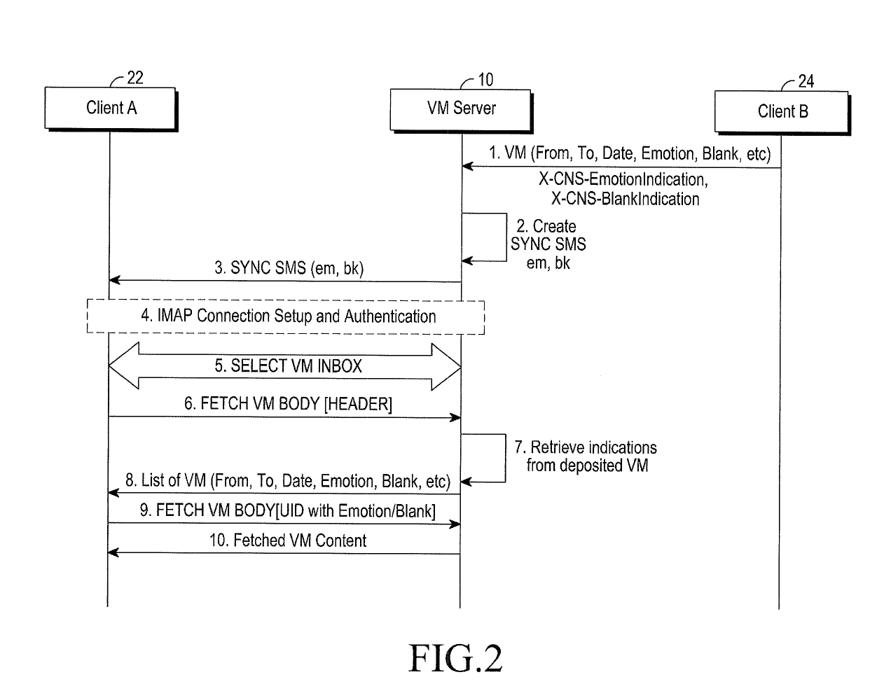

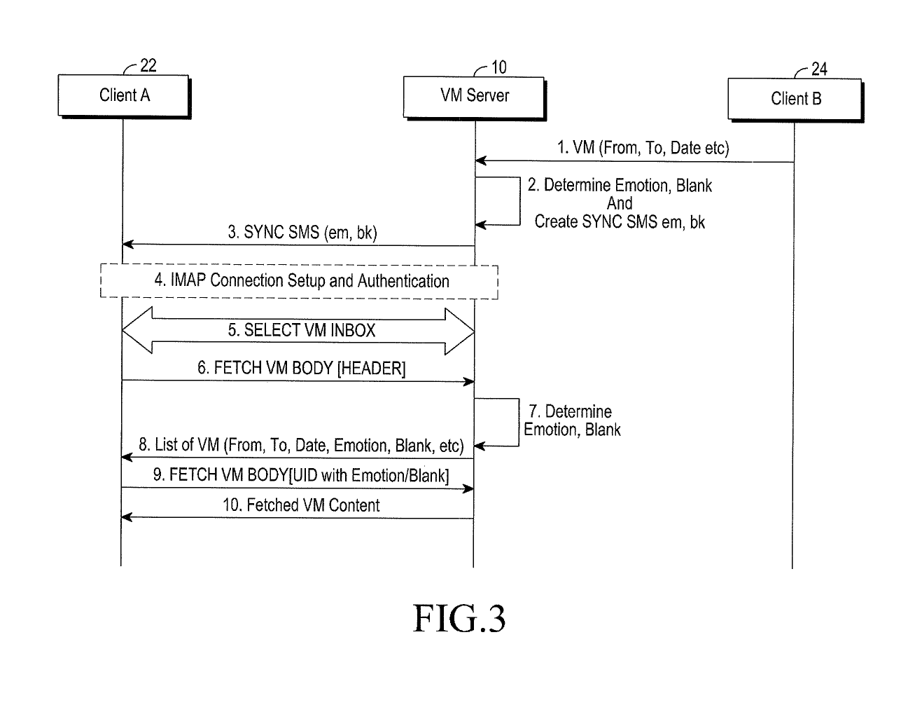

FIG. 2 is process flowchart diagram of a method for sending and receiving a voice mail in the voice mail system, as shown in FIG. 1, according to an embodiment of present invention. FIG. 3 is process flowchart diagram of a method for sending and receiving a voice mail in the voice mail system, as shown in FIG. 1, according to another embodiment of present disclosure. The new headers are independent of each other.

At step 1, emotion and blank indications are included in the VM being deposited via SMTP command, where SMTP DATA protocol unit includes the new headers.

### EXAMPLE

C: DATA

S: 354 Start mail input; end with <CRLF>.<CRLF>

C: Date: Thu, 21 May 1998 05:33:29-0700

C: From: John Q. Public <JQP@bar.com>

C: To: Jones@xyz.com

C: X-CNS-EmotionIndication: happy

C: X-CNS-BlankIndication: not-blank

C: . . . etc. etc. etc.

C: . . . etc. etc. etc.

C: .

S: 250 OK

C: QUIT

S: 221 foo.com Service closing transmission channel

The value for emotion indication header may be entered by the VM depositing user using the originating device or the client software may detect the value based on e.g., facial cues or voice cues in the VM being deposited. The value for blank indication header is usually determined by the client and included in the header.

At step 2, once the VM has been deposited on the VM server 10, the VM server 10 may send a SYNC SMS notification including emotion and blank indication headers. If the VM server 10 has not received these headers from the client B 24 then the VM server 10 may determine and fill the values in these headers. The value for emotion indication header may be entered by the VM server 10 by determining the value based on e.g., voice cues in the deposited VM.

At step 3, the VM server 10 may send the SYNC SMS notification including the emotion and blank indication headers as:

//VVM:SYNC:ev=NM;id=3446456;c=1;t=v;em=h;bk=nb;s=01234567898;dt=02 /08/2008 12:53+0200;1=30

At step 4, the client A 22 initiates IMAP connection setup to the VM server 10 and the user is authenticated by the VM server 10. This initiation by the client A 22 may be triggered by the received SYNC SMS notification.

At step 5, after the IMAP connection setup is successful, the client A 22 may SELECT VM INBOX and then the VM Server 10 sends the list of VM available for playback.

At step 6, the client A 22 may fetch VM headers of the VM's available for playback. In an example, the VM header may be fetched by the client A 22 with request C: a004 fetch 12 body [header].

At step 7, the VM server 10 either retrieves the emotion and blank indications from the deposited VM, if available, or the VM server 10 determines the emotion and blank indications by itself. At step 8, the VM server 10 returns the header information including emotion and blank indications.

### EXAMPLE

S: *12 FETCH (BODY[HEADER] {342}

S: Date: Wed, 17 Jul. 1996 02:23:25-0700 (PDT)

S: From: Terry Gray <gray@cac.washington.edu>

S: To: imap@cac.washington.edu

S: X-CNS-EmotionIndication: happy

S: X-CNS-BlankIndication: not-blank

S: Message-Id: <B27397-0100000@cac.washington.edu>

At step 9, the client can then selectively fetch the VM.

Example: C: A654 FETCH 2:4 (BODY[HEADER.FILEDS (EmotionIndication BlankIndication).

At step 10, the VM server 10 returns the selected VM. Example:

S: *2 FETCH . . .

S: *3 FETCH . . .

S: *4 FETCH . . .

S: A654 OK FETCH completed

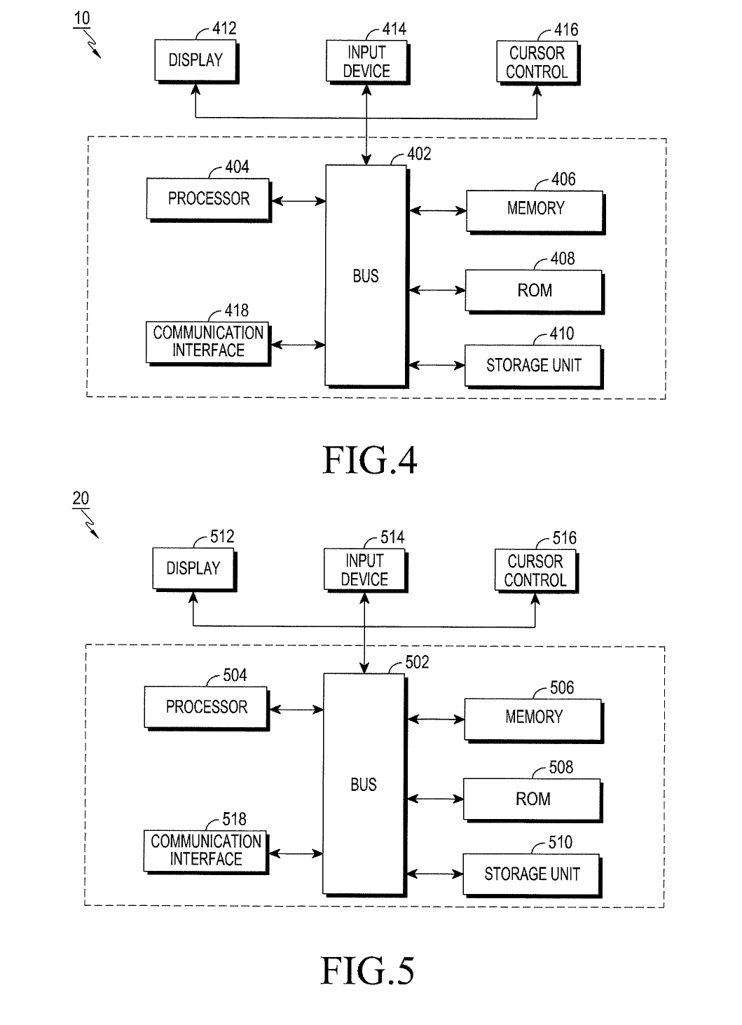

FIG. 4 is a block diagram illustrating a voice mail server comprised in the visual voice system such as those shown in FIG. 1, according to an embodiment of the present disclosure. The VM server 10 includes a bus 402 for communicating information, and a processor 404 coupled with the bus 402 for processing information. The VM server 10 also includes a memory 406, for example a random access memory (RAM) coupled to the bus 402 for storing information required by the processor 404. The memory 406 can be used for storing temporary information required by the processor 404. The VM server 10 further includes a read only memory (ROM) 408 coupled to the bus 402 for storing static information required by the processor 404. A storage unit 410, for example a magnetic disk, hard disk or optical disk, can be provided and coupled to bus for storing information.

The VM server 10 can be coupled via the bus 402 to a display 412, for example a cathode ray tube (CRT) or liquid crystal display (LCD), Light Emitting Diode (LED) for displaying information. An input device 414, including various keys, is coupled to the bus 402 for communicating information to the processor 404. In some embodiments, cursor control 416, for example a mouse, a trackball, a joystick, or cursor direction keys for communicating information to the processor 404 and for controlling cursor movement on the display 412 can also be present.

In one embodiment, the steps of the present disclosure are performed by the VM server 10 using the processor 404. The information can be read into the memory 406 from a machine-readable medium, for example the storage unit 410. In alternative embodiments, hard-wired circuitry can be used in place of or in combination with software instructions to implement various embodiments.

The term machine-readable medium can be defined as a medium providing data to a machine to enable the machine to perform a specific function. The machine-readable medium can be a storage media. Storage media can include non-volatile media and volatile media. The storage unit 410 can be a non-volatile media. The memory can be a volatile media. All such media must be tangible to enable the instructions carried by the media to be detected by a physical mechanism that reads the instructions into the machine.

Examples of the machine readable medium includes, but are not limited to, a floppy disk, a flexible disk, hard disk, magnetic tape, a CD-ROM, optical disk, punchcards, papertape, a RAM, a PROM, EPROM, and a FLASH-EPROM.

The VM server 10 also includes a communication interface 418 coupled to the bus 402 for enabling data communication. Examples of the communication interface 418 include, but are not limited to, an integrated services digital network (ISDN) card, a modem, a local area network (LAN) card, an infrared port, a Bluetooth port, a zigbee port, and a wireless port.

In some embodiments, the VM server 10 is able to receive user experience enhancing indications e.g., emotion and blank indications included in a voice mail being deposited over the communication interface 418. The processor 404 then parses the deposited voice mail to determine presence of user experience enhancing indications e.g., emotion and blank indications. The processor 404 then includes the user experience enhancing indications e.g., emotion and blank indications either received from the voice mail being deposited or determined by the processor 404 itself while creating and sending SYNC SMS notification over the communication interface 418. If the processor 404 is generating the IMAP notification or returning the voice mail content to the fetch request, the processor 404 includes user experience enhancing indications e.g., emotion and blank indications either received through the voice mail deposited or determined by the processor 404 itself.

In some embodiments, the processor 404 can include one or more processing units for performing one or more functions of the processor 404. The processing units are hardware circuitry performing specified functions.

FIG. 5 is a block diagram illustrating a client comprised in the visual voice system such as those shown in FIG. 1, according to an embodiment of present invention. The client 20 includes a bus 502 for communicating information, and a processor 504 coupled with the bus 502 for processing information. The client 20 also includes a memory 506, for example a random access memory (RAM) coupled to the bus 502 for storing information required by the processor 504. The memory 506 can be used for storing temporary information required by the processor 504. The client 20 further includes a read only memory (ROM) 508 coupled to the bus 502 for storing static information required by the processor 504. A storage unit 510, for example a magnetic disk, hard disk or optical disk, can be provided and coupled to the bus 502 for storing information.

The client 20 can be coupled via the bus 502 to a display 512, for example a cathode ray tube (CRT) or liquid crystal display (LCD) or Light Emitting Diode (LED), for displaying information. An input device 514, including various keys, is coupled to the bus 502 for communicating information to the processor 504. In some embodiments, cursor control 516, for example a mouse, a trackball, a joystick, or cursor direction keys for communicating information to the processor 504 and for controlling cursor movement on the display 512 can also be present.

In one embodiment, the steps of the present disclosure are performed by the client 20 using the processor 504. The information can be read into the memory 506 from a machine-readable medium, for example the storage unit 510. In alternative embodiments, hard-wired circuitry can be used in place of or in combination with software instructions to implement various embodiments.

The term machine-readable medium can be defined as a medium providing data to a machine to enable the machine to perform a specific function. The machine-readable medium can be a storage media. The storage media can include non-volatile media and volatile media. The storage unit 510 can be a non-volatile media. The memory 506 can be a volatile media. All such media must be tangible to enable the instructions carried by the media to be detected by a physical mechanism that reads the instructions into the machine. Examples of the machine readable medium includes, but are not limited to, a floppy disk, a flexible disk, hard disk, magnetic tape, a CD-ROM, optical disk, punchcards, papertape, a RAM, a PROM, EPROM, and a FLASH-EPROM.

The client 20 also includes a communication interface 518 coupled to the bus 502 for enabling data communication. Examples of the communication interface 502 include, but are not limited to, an integrated services digital network (ISDN) card, a modem, a local area network (LAN) card, an infrared port, a Bluetooth port, a zigbee port, and a wireless port.

In some embodiments, the client 20 is able to receive user experience enhancing indications e.g., emotion and blank indications included in the SNYC SMS, IMAP notification or voice message over the communication interface. The processor 504 then parses the user experience enhancing indications e.g., emotion and blank indications contained in the received SNYC SMS, IMAP notification, voice message fetch request or voice message and displays the user experience enhancing indications to the user on the display 512.

In some embodiments, the processor 504 can include one or more processing units for performing one or more functions of the processor e. The processing units are hardware circuitry performing specified functions.

The present invention can provide a method for different indications (emotions, blank) associated with the VM to recipient user.

1. A method for sending and receiving a voice mail in a voice mail server, the method comprising:
receiving the voice mail from a first client;
generating a notification short message including emotion indication or blank indication corresponding to the received voice mail; and
sending the notification short message to a second client.

2. The method of claim 1, further comprising:
sending a voice mail list requested by the second client to the second client.

3. The method of claim 1, further comprising:
sending voice mail content corresponding to a voice mail selected by the second client from among voice mails included in the voice mail list to the second client.

4. The method of claim 2, further comprising:
before sending the voice mail list to the second client, authenticating the second client if connection with the second client is performed.

5. The method of claim 2, wherein sending the voice mail list requested by the second client to the second client comprises:
searching for the emotion indication or the blank indication corresponding to the voice mail if a header of the voice mail is detected by the second client;
determining, whether the emotion indication or the blank indication is legal; and
sending the voice mail list including the voice mail corresponding to the emotion indication or the blank indication to the second client if the emotion indication or the blank indication is legal.

6. The method of claim 2, wherein sending the voice mail list requested by the second client list to the second client comprises:
identifying the emotion indication or the blank indication corresponding to the voice mail if a header of the voice mail is detected by the second client; and
sending the voice mail list including the voice mail corresponding to the emotion indication or the blank indication to the second client.

7. The method of claim 1, further comprising:
determining a value for a header for the emotion indication based on voice cues present in the received voice mail.

8. A method for sending and receiving a voice mail in a client, the method comprising:
receiving a notification short message from a voice mail server that has received the voice mail from a first client;
detecting a header of the voice mail from the notification short message;
requesting the voice mail server to send the voice mail based on the header; and
receiving voice mail content corresponding to the voice mail from the voice mail server.

9. The method of claim 8, wherein requesting the voice mail server to send the voice mail based on the header comprises:
receiving a voice mail list from the voice mail server; and
detecting the voice mail from the voice mail list and requesting the voice mail server to send the voice mail.

10. The method of claim 9, wherein receiving the voice mail list from the voice mail server comprises:
receiving the voice mail list including the voice mail corresponding to an emotion indication or a blank indication.

11. The method of claim 8, further comprising:
before detecting the header of the voice mail from the notification short message, performing connection with the voice mail server and authenticating the voice mail server.

12. The method of claim 8, wherein receiving the voice mail content corresponding to the voice mail from the voice mail server comprises:
if an emotion indication or a blank indication in the corresponding to the voice mail is legal, receiving the voice mail list including the voice mail corresponding to the emotion indication or the blank indication to the second client.

13. The method of claim 12, wherein a value for a header for the emotion indication is determined based on voice cues present in the voice mail.

14. A voice mail server for sending and receiving a voice mail, the voice mail server comprising:
a communication interface configured to receive the voice mail from a first client; and
a processor configured to control the communication interface to generate a notification short message including emotion indication or blank indication corresponding to the received voice mail and send the notification short message to a second client.

15. The voice mail server of claim 14, wherein the processor is configured to control the communication interface to send a voice mail list requested by the second client to the second client.

16. The voice mail server of claim 15, wherein the processor is configured to control the communication interface to send voice mail content corresponding to a voice mail selected by the second client from among voice mails included in the voice mail list to the second client.

17. The voice mail server of claim 15, wherein the processor is configured to authenticate the second client if the processor is connected with the second client.

18. The voice mail server of claim 15, wherein the processor is configured to control the communication interface to search for the emotion indication or the blank indication corresponding to the voice mail if a header of the voice mail is detected by the second client, determine whether the emotion indication or the blank indication is legal, and send the voice mail list including the voice mail corresponding to the emotion indication or the blank indication to the second client if the emotion indication or the blank indication is legal.

19. The voice mail server of claim 14, wherein the processor is configured to control the communication interface to identify the emotion indication or the blank indication corresponding to the voice mail if a header of the voice mail is detected by the second client and to send the voice mail list including the voice mail corresponding to the emotion indication or the blank indication to the second client.

20. The voice mail server of claim 14, wherein the processor is configured to determine a value for a header for the emotion indication based on voice cues present in the received voice mail.
